(19) United States
(12) Patent Application Publication
(10) Pub. No.: US 2010/0170870 A1
(43) Pub. Date: Jul. 8, 2010

(54) IMPRINT PROCESS OF THERMOSETTING MATERIAL

(75) Inventors: Yung-Chun LEE, TAINAN CITY (TW); Cheng-Yu CHIU, TAOYUAN COUNTY (TW); Chung-Yi LEE, MIAOLI COUNTY (TW)

Correspondence Address: BRIAN M. MCINNIS, 12th Floor, Ruttonjee House, 11 Duddell Street, Hong Kong, HK

(73) Assignee: NATIONAL CHENG KUNG UNIVERSITY, TAINAN CITY (TW)

(21) Appl. No.: 12/542,716

(22) Filed: Aug. 18, 2009

(30) Foreign Application Priority Data
Jan. 8, 2009 (TW) 98100535

(51) Int. Cl. B44C 1/22

(52) U.S. Cl. 216/44

(57) ABSTRACT

An imprint process of a thermosetting material is described, comprising: providing a mold including pattern structures, wherein convex portions and concave portions of the pattern structures are covered with a transferred material layer; providing a substrate, wherein a thermosetting material layer and a sacrificial layer cover the substrate in sequence; performing an imprint step to transfer the transferred material layer on the convex portions onto a first portion of the sacrificial layer; etching a second portion of the sacrificial layer and the underlying thermosetting material layer by using the transferred material layer as a mask; and performing a wet stripping step by using a stripper to completely etch the sacrificial layer and the overlying transferred material layer, wherein the stripper has a first etching rate and a second etching rate to the thermosetting material layer and the sacrificial layer respectively, and a ratio of the second etching rate to the first etching rate is greater than or equal to 30.

### RELATED APPLICATIONS

This application claims priority to Taiwan Application Serial Number 98100535, filed Jan. 8, 2009, which is herein incorporated by reference.

### FIELD OF THE INVENTION

The present invention relates to an imprint process, and more particularly to an imprint process of a thermosetting material.

### BACKGROUND OF THE INVENTION

A thermosetting material, such as polyimide (PI), is a material with high heat resistance, a great mechanical property, a superior optical property and a low dielectric constant, so that the thermosetting material has been widely applied in flexible printed circuit (FPC) boards, electronic packages, optical waveguides, alignment films of liquid crystal displays (LCD) and microfluidic devices. In the application, the thermosetting material typically needs to be patterned by a pattern definition technology to form the desired pattern structure for use.

Several technologies, such as laser machining technology, conventional photolithography technology, new photolithography technology, and nano-imprint technology including, for example soft imprint technology and hot-embossing technology, have been developed to pattern the thermosetting material. When the laser machining technology patterns the thermosetting material, the laser directly irradiates the thermosetting material layer through a mask to remove a portion of the thermosetting material layer to complete the thermosetting material pattern structures. However, when the laser machining technology patterns the thermosetting material, irradiation of many laser shots is required, so that the process is time-consuming and consumes large amounts of laser energy, thereby increasing the cost. Moreover, due to the size of the laser beam and the optical diffraction limit, the laser machining technology cannot produce the pattern with too small size, such as the thermosetting material pattern structures with the nanometer scale.

When the conventional photolithography technology is used to pattern a thermosetting material layer, a photoresist layer is firstly coated on the thermosetting material layer, the photoresist layer is patterned by the exposure and development technology, and then the thermosetting material layer is etched with tile patterned photoresist layer as the etching mask to complete the thermosetting material pattern structures. However, due to the wavelength limit of the exposure light source, the feature size of the thermosetting material pattern strictures produced by the conventional photolithography technology has a limit, so that the pattern structures with a smaller size cannot be produced.

When the new photolithography technology is used to pattern the thermosetting material, a photosensitive thermosetting material is needed, the bonding link in parts of directions of the thermosetting material is destroyed by directly using the light source, such as deep ultraviolet, and the exposed thermosetting material layer is developed to complete the pattern structures of the thermosetting material. However, the surface roughness of the thermosetting material pattern structure formed by the new photolithography technology is poor, there still exists many issues in the positive tone and negative tone photosensitive thermosetting materials, such as that the adjustment of the ingredients of the material is difficult, and the control of the process parameters and the machining precision of the thermosetting material is difficult to result in the poor fidelity and the reliability of pattern transferring. In addition, similarly, due to the wavelength limit of the exposure light source, the new photolithography technology cannot produce the thermosetting material pattern structures with a smaller size. Furthermore, the negative tone photosensitive thermosetting material is swelling after the developing process, so that the fidelity of the pattern transferring is further decreased.

When the soft nanoimprint technology is used to pattern the thermosetting material, such as polyimide, and the imprint mold is pressed into the liquid poly(amic acid) (PAA) that has not been heated to form the solid polyimide, it is easy for bubbles to form between the pattern structures of the imprint mold and the liquid poly(amic acid) after heating, and these bubbles are formed on the surface of the polyimide. Therefore, the surface of the pattern structures of the thermosetting material formed by the soft nanoimprint technology has many holes, so that the surface roughness of the thermosetting material pattern structures is poor, and the mechanical strength of the thermosetting material pattern structures is reduced. Moreover, when the liquid poly(amic acid) is heated to solidify the liquid poly(amic acid) to form the polyimide before the mold is removed, the solvent of the poly(amic acid) is evaporated, so that the volume of the thermosetting material pattern structures is decreased to lower the fidelity of the pattern transferring.

When the hot embossing nanoimprint technology is used to pattern the thermosetting material, the imprint temperature needs to be raised to more than the glass transition temperature (Tg) 300° C. of the thermosetting material. In addition, due to the heat, the remaining thermal stress, the expansion and the shrink effects occur on the mold and the substrate simultaneously, thereby seriously affecting the substrate material and the size of the thermosetting material pattern structures to reduce the reliability of the pattern transferring.

### SUMMARY OF THE INVENTION

Therefore, one objective of the present invention is to provide an imprint process of a thermosetting material, which can accurately transfer a pattern on an imprint mold to a thermosetting material layer, thereby effectively increasing the accuracy and the reliability of the pattern transferred to the thermosetting material layer.

Another objective of the present invention is to provide an imprint process of a thermosetting material, which can successively define the pattern of the thermosetting material with low thermal budget and under relatively lower temperatures compared with the hot embossing nanoimprint process, thereby reducing the process cost and preventing the feature size of the transferred pattern of the thermosetting material from being distorted. Furthermore, the remaining thermal stress formed on the substrate and the thermosetting material layer due to high temperature can be decreased, and the substrate and the thermosetting material layer can be prevented from being damaged.

According to the aforementioned objectives, the present invention provides an imprint process of a thermosetting material, comprising: providing a mold including a pattern structure, wherein the pattern structure comprises a plurality of convex portions and a plurality of concave portions; forming a transferred material layer on the convex portions and the concave portions; providing a substrate, wherein a surface of the substrate is covered with a thermosetting material layer and a sacrificial layer in sequence; performing an imprint step to transfer the transferred material layer on the convex portions onto a first portion of the sacrificial layer and to expose a second portion of the sacrificial layer; dry etching the second portion of the sacrificial layer and a second portion of the underlying thermosetting material layer to remain the first portion of the sacrificial layer and a first portion of the underlying thermosetting material layer by using the transferred material layer as a mask; and performing a wet stripping step by using a stripper to completely etch the first portion of the sacrificial layer and to lift off the overlying transferred material layer, wherein the stripper has a first etching rate and a second etching rate to the thermosetting material layer and the sacrificial layer respectively, and a ratio of the second etching rate to the first etching rate is greater than or equal to 30.

According to a preferred embodiment of the present invention, the material of the sacrificial layer may be PMMA 950K A6 provided by MicroChem Corp., Newton, Mass., U.S.A. or photoresist S1818 provided by Shipley Company, L.L.C., Marlborough, Mass., U.S.A., the stripper may be acetone, such as TAIMAX acetone provided by Taiwan Maxwave Co., Ltd.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIGS. 1A through 1H are schematic flow diagrams showing an imprint process of a thermosetting material in accordance with a preferred embodiment of the present invention.

### DETAILED DESCRIPTION OF THE PREFERRED EMBODIMENT

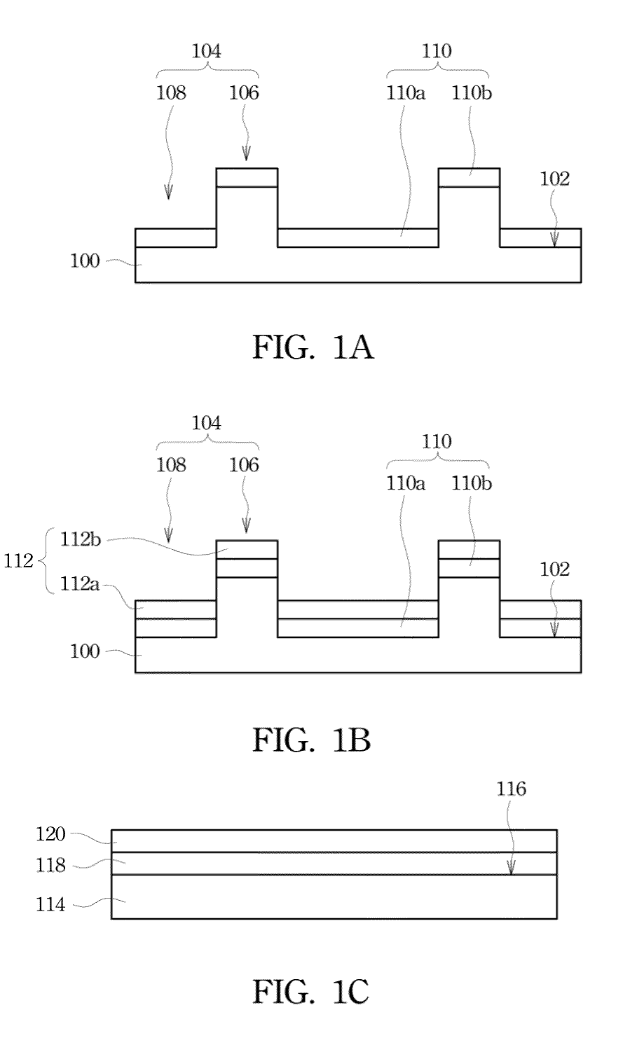

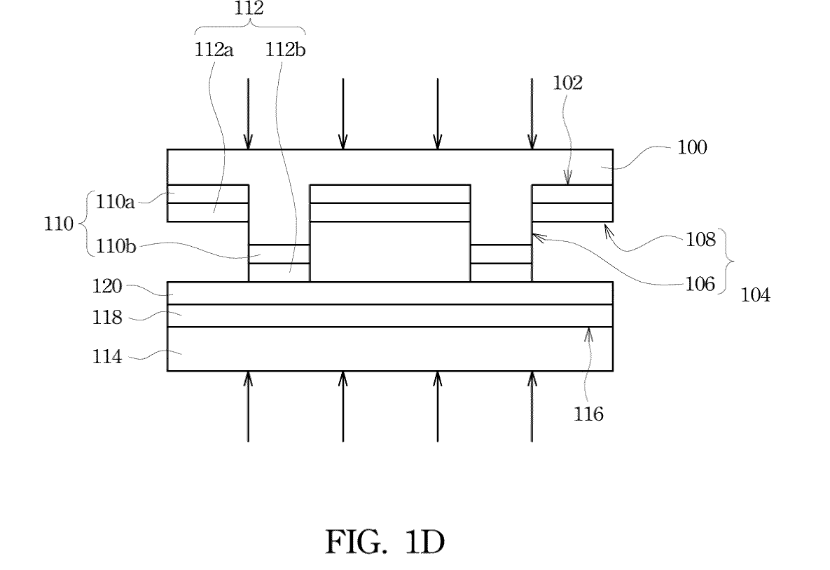

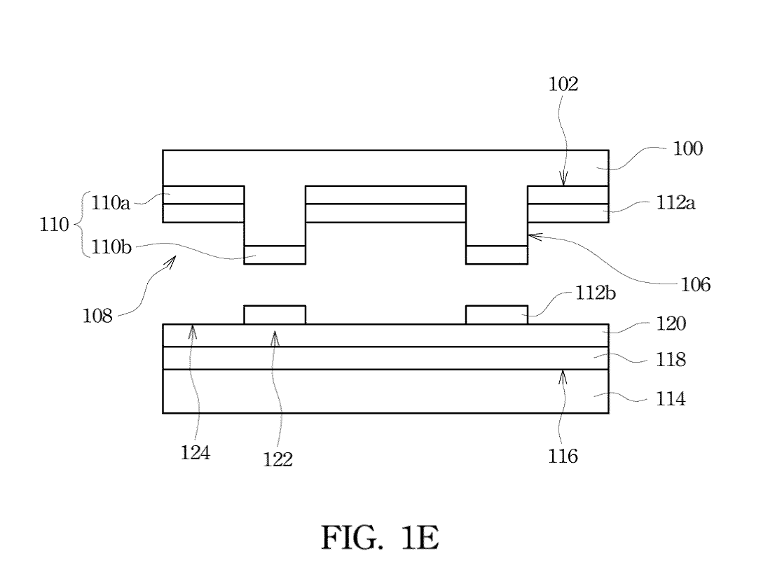

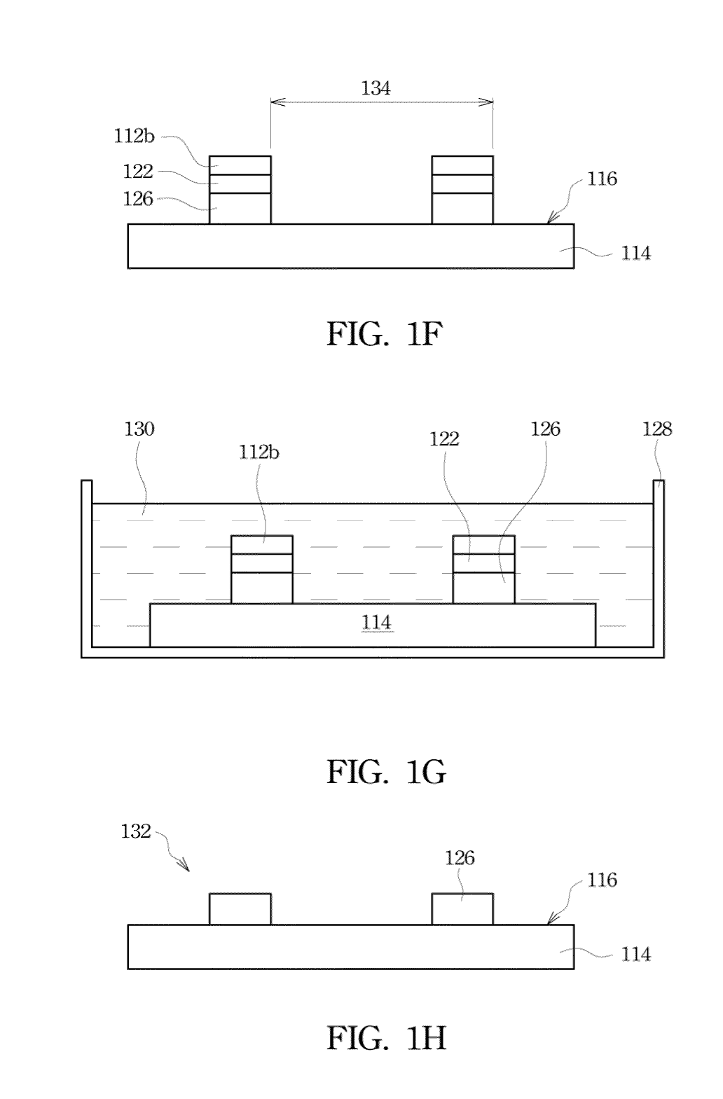

FIGS. 1A through 1H are schematic flow diagrams showing an imprint process of a thermosetting material in accordance with a preferred embodiment of the present invention. In an exemplary embodiment, when the imprint process of a thermosetting material is performed, a mold 100 may be provided to perform the imprint process. A pattern structure 104 is set in a surface 102 of the mold 100, wherein the pattern structure 104 comprises a plurality of concave portions 108 and a plurality of convex portions 106. The feature size of the pattern structure 104 may be micrometer scale or nanometer scale. Next, such as shown in FIG. 1A, an anti-stick layer 110 is selectively formed to cover the pattern structure 104 of the mold 100 by, for example, a thermal evaporation method, wherein the anti-stick layer 110 includes two portions 110a and 110b, the portion 110a of the anti-stick layer 110 covers on bottoms of the concave portions 108 of the pattern structure 104, and the portion 110b of the anti-stick layer 110 covers on top surfaces of the convex portions 106 of the pattern structure 104. In another exemplary embodiment, when the material of the mold 100 itself has an anti-stick property, such as ethylene tetrafluoroethylene [—(C2H4-C2F4)-] provided by DuPont Company, the anti-stick layer 110 does not need to be formed additionally.

Next, such as shown in FIG. 1B, a transferred material layer 112 is formed on the anti-stick layer 110 by using, for example a thermal evaporation method, an e-beam evaporation method, a chemical vapor deposition method or a physical vapor deposition method cooperating with a typical pattern definition technique, wherein the transferred material layer 112 also includes portions 112a and 112b, the portions 112a of the transferred material layer 112 are located on the portion 110a of the anti-stick layer 110 within the concave portions 108 of the pattern structure 104, and the portions 112b of the transferred material layer 112 are located on the portion 111b of the anti-stick layer 110 on the top surfaces of the convex portions 106 of the pattern structure 104. In another exemplary embodiment, when the material of the mold 100 itself has an anti-stick property and the anti-stick layer 110 is not formed, the transferred material layer 112 directly covers the pattern structure 104 of the mold 100, wherein the portions 112a of the transferred material layer 112 are directly located on die bottoms of the concave portions 108 of the pattern structure 104, and the portions 112b of the transferred material layer 112 are directly located on the top surfaces of the convex portions 106 of the pattern structure 104. The material of the transferred material layer 112 may be metal, oxide or a dielectric material. In one embodiment, the material of the transferred material layer 112 may be chromium (Cr). In another embodiment, the material of the transferred material layer 112 may be a dielectric material and oxide, such as silicon dioxide (SiO₂). By disposing the anti-stick layer 110 or adopting the mold 100 having an anti-stick property, the portions 112b of the transferred material layer 112 on the convex portions 106 of the mold 100 can be successively separated from the convex portions 106 of the mold 100.

Simultaneously, a substrate 114 desired to be imprinted is provided, wherein the substrate 114 is preferably composed of a material that can resist the etching of the stripper 130 (referring to FIG. 1G). The material of the substrate 114 may be, for example, silicon wafer, glass, quartz or metal. A thermosetting material layer 118 is formed to cover a surface 116 of the substrate 114 by, for example, a physical vapor deposition method, a chemical vapor deposition method or a coating method. In some embodiments, the material of the thermosetting material layer 118 may be, for example, polyimide or polyethersulfone (PES), wherein each polyimide and polyethersulfone is a material having a high glass transition temperature. In an exemplary embodiment, the material of the thermosetting material layer 118 may be RN-1349 polyimide provided by Nissan Chemical Industries. Next, the thermosetting material layer 118 may be baked to dry the solvent in the thermosetting material layer 118. Then, such as shown in FIG. 1C, a sacrificial layer 120 is formed to cover the thermosetting material layer 118 by, for example, a deposition method or a coating method. In an exemplary embodiment, the material of the sacrificial layer 120 may be polymethylmethacrylate (PMMA) or photoresist S1818 provided by Shipley Company, L.L.C., Marlborough, Mass., U.S.A. The material of the sacrificial layer 120 also may be PMMA 950K A6 provided by MicroChem Corp., Newton, Mass., U.S.A. The choice of the materials of the thermosetting material layer 118 and the sacrificial layer 120 is in relation to the stripper 130 (referring to FIG. 1G), wherein the stripper 130 has two different etching rates to the thermosetting material layer 118 and the sacrificial layer 120 respectively, and the etching rate of the stripper 130 to the sacrificial layer 120 is much larger than that of the stripper 130 to the thermosetting material layer 118. Therefore, when the sacrificial layer 120 is completely removed by the stripper 130, the thermosetting material layer 118 may hardly be etched by the stripper 130 and is kept. In an exemplary embodiment, the ratio of the etching rate of the stripper 130 to the sacrificial layer 120 to the etching rate of the stripper 130 to the thermosetting material layer 118 may be preferably larger than or equal to 30, more preferably be larger than or equal to 40, and further more preferably be larger than or equal to 50.

Next, referring to FIG. 1D, an imprint step is performed, wherein the surface 102 of the mold 100 is oppositely pressed on the surface 116 of the substrate 114 to press the portions 112b of the transferred material layer 112 on the convex portions 106 of the pattern structure 104 of the mold 100 on the liquid status of the sacrificial layer 120 on the substrate 114 and contact with the sacrificial layer 120. After the portions 112b of the transferred material layer 112 on the mold 100 are pressed on the sacrificial layer 120 on the substrate 114, the sacrificial layer 120 is baked at substantially 95° C. in substantially five minutes to dry the sacrificial layer 120. After the temperature is lowered to room temperature, the mold 100 is removed from the sacrificial layer 120. At this time, the convex portions 106 of the pattern structure 104 of the mold 100 are covered with the anti-stick layer 110 to make the anti-stick layer 110 be located between the surface 102 of the mold 100 and the transferred material layer 112, or the mold 100 itself has an anti-stick property, so that the portions 112b of the transferred material layer 112 on the convex portions 106 of the pattern structure 104 of the mold 100 can be successfully separated from the mold 100 to transfer to the surface of the sacrificial layer 120 to complete the imprint step. After the imprint step is completed, the portions 112b of the transferred material layer 112 are only transferred to a first portion 122 of the sacrificial material layer 120, and a second portion 124 of the sacrificial layer 120 is exposed, such as shown in FIG. 1E.

Next, referring to FIG. 1F, the second portion 124 of the sacrificial layer 120 uncovered by the portions 112b of the transferred material layer 112 and the portion of the thermosetting material layer 118 underlying the second portion 124 are removed until a portion of the surface 116 of the substrate 114 underlying the second portion 124 of the sacrificial layer 120 is exposed, and the first portion 122 of the sacrificial layer 120 and a first portion 126 of the thermosetting material layer 118 underlying the first portion 122 are maintained. In another embodiment, according to the difference of the applications of the products, the removal step may only remove the second portion 124 of the sacrificial layer 120 and a portion of the thermosetting material layer 118 underlying the second portion 124 of the sacrificial layer 120 to keep the first portion 122 of the sacrificial layer 120, the other portion of the thermosetting material layer 118 underlying the second portion 124 of the sacrificial layer 120, and the first portion 126 of the thermosetting material layer 118 underlying the first portion 122. Accordingly, the surface 116 of the substrate 114 underlying the second portion 124 of the sacrificial layer 120 is not exposed. In a preferred embodiment, in the removal of a portion of the sacrificial layer 120 and a portion of the thermosetting material layer 118, an etching method, such as a dry etching method, may be adopted, and the portions 112b of the transferred material layer 112 on the first portion 122 of the sacrificial layer 120 may be used as the etching mask to etch and remove the portion of the sacrificial layer 120 and the portion of the thermosetting material layer 118. The dry etching method may be, for example, a reactive ion etching (RIE) technique or an inductively coupled plasma (ICP) ion etching technique. In some embodiments, when the dry etching method, such as the reactive ion etching method or the inductively coupled plasma ion etching method, is used to perform the etching of the sacrificial layer 120 and the thermosetting material layer 118, oxygen may be used as the main reactive gas. For example, oxygen, or oxygen and argon of specially designated ratio may be used as the etching reactive gas. In the present exemplary embodiment, the adjacent portions 112b of the transferred material layer 112 pressed on the first portion 122 of the sacrificial layer 120 have a pitch 134.

According to the experiment discovery, the photosensitive photoresist material is used as the etching mask to pattern the thermosetting material layer in the conventional photolithography technique, and the photoresist layer swells due to that the photoresist layer absorbing a portion of the developer during the development process, so that the volume of the photoresist layer is expanded. Therefore, when the photoresist layer with the expanded volume is used as the etching mask to etch the pattern of the underlying material layer, the feature size of the formed pattern structure of the material layer is distorted. However, in a preferred embodiment of the present invention, the portions 112b of the transferred material layer 112 on the first portion 122 of the sacrificial layer 120 are used as the etching mask without using the photoresist layer as the etching mask, and the transferred material layer 112 does not experience the exposing and developing process, so that the transferred material layer 112 will not swell due to the developer. Therefore, by using the transferred material layer 112 as the dry etching mask, it can ensure that the pattern structures of the etched sacrificial layer 120 and the thermosetting material layer 118 are not distorted to greatly increase the fidelity of the achieved pattern structures of the sacrificial layer 120 and the thermosetting material layer 1118.

Then, referring to FIG. 1G, a stripping tank 128 that can resist the etching of the stripper 130 is provided, wherein the stripping tank 128 is filled with the stripper 130 for the wet stripping step. Next, the substrate 114, and the portions 112b of the transferred material layer 112, the first portion 122 of the sacrificial layer 120 and the first portion 126 of the thermosetting material layer 118 on the substrate 114 are entirely immersed in the stripper 130 in the stripping tank 128 to use the stripper 130 to completely etch and remove the first portion 122 of the sacrificial layer 120 and to lift off the portions 112b of the transferred material layer 112 on the first portion 122 of the sacrificial layer 122 while the thermosetting material layer 118 may hardly be etched by the stripper 130. Therefore, the etching rate of the stripper 130 to the first portion 122 of the sacrificial layer 120 must be far larger than that of the stripper 130 to the first portion 126 of the thermosetting material layer 118. In one embodiment, the ratio of the etching rate of the stripper 130 to the sacrificial layer 120 to the etching rate of the stripper 130 to the thermosetting material layer 118 may be, for example, larger than or equal to 30, more preferably be larger than or equal to 40, and further more preferably be larger than or equal to 50.

In a preferred embodiment, the thermosetting material layer 118 may be composed of, for example, RN-1349 polyimide provided by Nissan Chemical Industries, the sacrificial layer 120 may be composed of, for example, PMMA, such as PMMA 950K A6 provided by MicroChem Corp., Newton, Mass., U.S.A., and the stripper 130 may be composed of TAIMAX acetone provided by Taiwan Maxwave Co., Ltd. In another preferred embodiment, the thermosetting material layer 118 may be RN-1349 polyimide provided by Nissan Chemical Industries, the sacrificial layer 120 may be photoresist S1818 provided by Shipley Company, L.L.C., Marlborough, Mass., U.S.A., and the stripper 130 may be acetone, such as TAIMAX acetone provided by Taiwan Maxwave Co., Ltd. After the etching of the first portion 122 of the sacrificial layer 120 is completed, the substrate 114 and the first portion 126 of the thermosetting material layer 118 on the substrate 114 are removed from the stripping tank 128 and are rinsed with the deionized water, and then a heating and baking treatment is performed to bake under substantially 100° C. for substantially three minutes. The first portion 126 of the thermosetting material layer 118 remained on the substrate 114 is the pattern structure 132 with the desired pattern, and the pattern of the pattern structure 132 are completely and reliably transferred from the pattern of the pattern stricture 104 of the mold 100.

The etching rate of the stripper 130 to the thermosetting material layer 118 is very small, and the etching rate of the stripper 130 to the sacrificial layer 120 is much larger than that of the stripper 130 to the thermosetting material layer 118, so that the sacrificial layer 120 can be completely etched by the stripper 130 in a very short time. Therefore, when the sacrificial layer 120 has been completely removed by the stripper 130, the first portion 126 of the thermosetting material layer 118 is hardly etched by the stripper 130 and is almost retained entirely, so as to precisely and exactly transfer the pattern of the pattern structure 104 of the mold 100 to the thermosetting material layer 118 to obtain the pattern structure 132 with the desired pattern. Accordingly, the pattern of the imprint mold 100 can be reliably transferred to the thermosetting material layer 118 with low thermal budget. Therefore, the fidelity and the reliability of the pattern transferred from the mold 100 to the thermosetting material layer 118 can be increased, and the process cost can be greatly reduced due to the decrease of the thermal budget.

According to the aforementioned embodiments of the present invention, one advantage of the present invention is that an imprint process of a thermosetting material of the present invention can accurately transfer a pattern on an imprint mold to a thermosetting material layer, thereby effectively increasing the accuracy and the reliability of the pattern transferred to the thermosetting material layer. Furthermore, the imprint process can be completed under the relatively lower temperature compared with the hot embossing nanoimprint process, so that the remaining thermal stress formed on the substrate and the thermosetting material layer due to high temperature can be decreased, and the substrate and the thermosetting material layer can be prevented from being damaged.

According to the aforementioned embodiments of the present invention, another advantage of the present invention is that an imprint process of a thermosetting material of the present invention can successively define the pattern of the thermosetting material with low thermal budget, thereby reducing the process cost and preventing the feature size of the transferred pattern of the thermosetting material from being distorted.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An imprint process of a thermosetting material, comprising:
providing a mold including a pattern structure, wherein the pattern structure comprises a plurality of concave portions and a plurality of convex portions;
forming a transferred material layer on the convex portions and the concave portions;
providing a substrate, wherein a surface of the substrate is covered with a thermosetting material layer and a sacrificial layer in sequence;
performing an imprint step to transfer the transferred material layer on the convex portions onto a first portion of the sacrificial layer and to expose a second portion of the sacrificial layer;
etching the second portion of the sacrificial layer and a second portion of the underlying thermosetting material layer to remain the first portion of the sacrificial layer and a first portion of the underlying thermosetting material layer by using the transferred material layer as a mask; and
performing a wet stripping step by using a stripper to completely etch the first portion of the sacrificial layer and to lift off the overlying transferred material layer, wherein the stripper has a first etching rate and a second etching rate to the thermosetting material layer and the sacrificial layer respectively, and a ratio of the second etching rate to the first etching rate is greater than or equal to 30.

2. The imprint process of a thermosetting material according to claim 1, wherein a material of the transferred material layer is metal, oxide or a dielectric material.

3. The imprint process of a thermosetting material according to claim 1, wherein a material of the transferred material layer is chromium.

4. The imprint process of a thermosetting material according to claim 1, wherein a material of the sacrificial layer is polymethylmethacrylate (PMMA).

5. The imprint process of a thermosetting material according to claim 4, wherein the stripper is acetone.

6. The imprint process of a thermosetting material according to claim 1, wherein
a material of the thermosetting material layer is RN-1349 polyimide provided by Nissan Chemical Industries;
a material of the sacrificial layer is polymethylmethacrylate (PMMA); and
a material of the stripper is TAIMAX acetone provided by Taiwan Maxwave Co., Ltd.

7. The imprint process of a thermosetting material according to claim 1, wherein
a material of the thermosetting material layer is RN-1349 polyimide provided by Nissan Chemical Industries;
a material of the sacrificial layer is photoresist S1818 provided by Shipley Company, L.L.C., Marlborough, Mass., U.S.A.; and
a material of the stripper is acetone.

8. The imprint process of a thermosetting material according to claim 1, wherein
a material of the sacrificial layer is PMMA 950K A6 provided by MicroChem Corp., Newton, Mass., U.S.A.; and
a material of the stripper is TAIMAX acetone provided by Taiwan Maxwave Co., Ltd.

9. The imprint process of a thermosetting material according to claim 1, wherein
a material of the sacrificial layer is photoresist S1818 provided by Shipley Company, L.L.C., Marlborough, Mass., U.S.A.; and
a material of the stripper is TAIMAX acetone provided by Taiwan Maxwave Co., Ltd.

10. The imprint process of a thermosetting material according to claim 1, wherein a material of the stripper is TAIMAX acetone provided by Taiwan Maxwave Co., Ltd.

11. The imprint process of a thermosetting material according to claim 1, wherein the transferred material layer is formed by a thermal evaporation method, an e-beam evaporation method, a chemical vapor deposition method or a physical vapor deposition method.

12. The imprint process of a thermosetting material according to claim 1, wherein the ratio of the second etching rate to the first etching rate is greater than or equal to 40.

13. The imprint process, of a thermosetting material according to claim 12, wherein the ratio of the second etching rate to the first etching rate is greater than or equal to 50.

14. The imprint process of a thermosetting material according to claim 12, wherein the step of etching the second portion of the sacrificial layer and the second portion of the thermosetting material layer is performed by a dry etching process.

15. The imprint process of a thermosetting material according to claim 14, wherein the dry etching process is a reactive ion etching (RIE) process or an inductively coupled plasma (ICP) ion etching process.

16. The imprint process of a thermosetting material according to claim 15, wherein the dry etching process uses oxygen as a main reactive gas.

17. The imprint process of a thermosetting material according to claim 1, wherein a material of the mold is ethylene tetrafluoroethylene provided by DuPont Company.

18. The imprint process of a thermosetting material according to claim 1, between the step of providing the mold and the step of forming the transferred material layer, further comprising forming an anti-stick layer on the convex portions and the concave portions of the mold.

19. The imprint process of a thermosetting material according to claim 1, wherein the imprint step further comprises:
pressing the transferred material layer on the convex portions of the pattern structure of the mold on the sacrificial layer on the substrate;
performing a baking step on the sacrificial layer to dry the sacrificial layer; and
removing the mold.

20. The imprint process of a thermosetting material according to claim 19, wherein the baking step is performed at substantially 95° C. in substantially five minutes.

21. The imprint process of a thermosetting material according to claim 1, after the wet stripping step, further comprising:
rinsing the substrate and the first portion of the thermosetting material layer by deionized water; and
performing a heating and baking step on the substrate and the first portion of the thermosetting material layer.

22. The imprint process of a thermosetting material according to claim 21, wherein the heating and baking step is performed under substantially 100° C. for substantially three minutes.

23. The imprint process of a thermosetting material according to claim 1, wherein a material of the thermosetting material layer is polyimide (PI) or polyethersulfone (PES).
